(19) United States
(12) Patent Application Publication
(10) Pub. No.: US 2023/0260685 A1
(43) Pub. Date: Aug. 17, 2023

(54) ADHESIVE BONDING COATING WITH MAGNETIC FILLERS

(71) Applicant: FORD GLOBAL TECHNOLOGIES, LLC, Dearborn, MI (US)

(72) Inventors: Leyi Zhu, Novi, MI (US); Franco Leonardi, Dearborn Heights, MI (US); Michael W. Degner, Novi, MI (US)

(21) Appl. No.: 17/670,709

(22) Filed: Feb. 14, 2022

(51) Int. Cl. H01F 1/153; H01F 3/08; H01F 27/245; H01F 27/255

(52) U.S. Cl. CPC H01F 1/15308; H01F 3/08; H01F 27/245; H01F 27/255

(57) ABSTRACT

Magnetic cores including a bonding material having magnetic filler therein is disclosed, as well as devices including the same. The magnetic cores may have superior magnetic properties or adopt the benefits of both soft magnetic composite cores and laminate cores. The magnetic cores disclosed herein exhibit greater relative magnetic permeability in the normalized direction as well as greater saturation flux density.

### TECHNICAL FIELD

The present disclosure relates to adhesives, glues, and bonding coatings for lamination cores.

### BACKGROUND

Lamination cores are a form of magnetic core widely used in electromagnetic and electromechanical devices such as but not limited to transformers, generators, inductors, stators, and rotors of electric machines. Lamination cores are steel sheets that are adhered, glued, or bonded together. For example, a self-bonding coating may be pre-applied to the sheets to later be activated such as by heat to form a magnetic lamination core from a stack of laminations.

### SUMMARY

A magnetic core including a stack of iron-containing sheets and an adhesive between the sheets is disclosed. The adhesive includes a resin and a magnetic filler.

An electric machine including steel laminations and a bonding material is also disclosed. The bonding material is disposed between the steel laminations. The bonding material includes an epoxy resin and magnetic filler dispersed therein.

An electric machine including a rotor and a stator is disclosed. The rotor includes a first magnetic core, and the stator includes a second magnet core. Each magnet core includes a stack of laminations and an adhesive disposed between the laminations. The adhesive of the rotor includes a first resin, and the adhesive of the stator includes a second resin with magnetic filler disposed therein.

### BRIEF DESCRIPTION OF THE DRAWINGS

FIG. 1 is a cross-sectional schematic view of a portion of a lamination core.

FIG. 2 is a graph depicting relative magnetic permeability with respect to the stacking factor of the lamination core.

FIG. 3A is a graph depicting saturation flux density (Jₛ) of various cores.

FIG. 3B is a graph depicting normal direction relative magnetic permeability (μᵣ) of various cores.

FIG. 3C is a graph depicting tangential direction relative magnetic permeability (μᵣ) of various cores.

FIGS. 4A-4C depict various cores and their magnetic flow path.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Unless expressly stated to the contrary, percent, “parts of,” and ratio values are by weight. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” or “generally” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

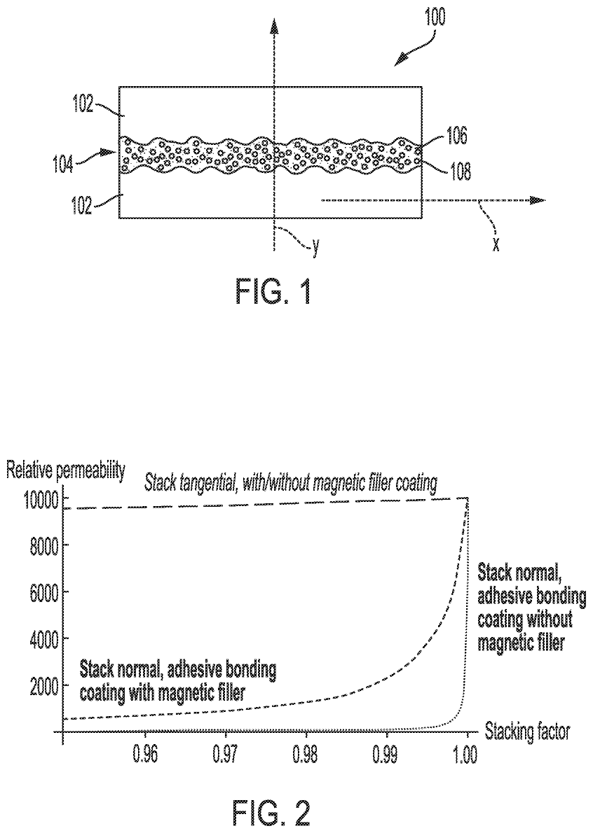

A magnetic core 100, as shown in FIG. 1, is disclosed. The magnetic core 100 may include a stack of iron-containing sheets 102 with adhesive, glue, or bonding material 104 therebetween. The magnetic core 100 may be used in various electric machines and/or electric devices. For example, a magnetic core 100 may be included in transformers, generators, inductors, stators, and rotors. Magnetic cores include materials having magnetic properties. The magnetic core 100 may increase the strength of a magnetic field generated by a coil carrying current.

The iron-containing sheets 102 may have ferromagnetic properties. For example, iron-containing sheets 102 may be steel sheets 102. The steel sheets 102 may be an electrical/lamination steel configured for particular magnetic properties such as small hysteresis, i.e., with coercivity less than 100 A/m. The electrical/lamination steel may include silicon present in an amount of 0.1 to 10%, or more preferably 0.5 to 6.5%, or even more preferably 1.0 to 3.5% by weight. The electrical/lamination steel may also include manganese and/or aluminum. For example, manganese and/or aluminum may each be present at 0.01 to 1%, or more preferably 0.05 to 0.75%, or even more preferably 0.1 to 0.5% by weight. The sheets 102 may have a thickness or no more than 5 mm, or more preferably no more than 2 mm, or even more preferably no more than 1 mm.

The adhesive, glue, or bonding material 104 may be disposed between and/or covering surfaces of the iron-containing sheets 102. The adhesive, glue, or bonding material 104 may be pre-applied to the sheets 102 before stacking (e.g., stamping) or applied within a die or mold during stamping. The adhesive, glue, or bonding material 104 may be applied at selective portions of the surface or applied as a coating such that it covers a portion or entire surface of the sheets 102. Coated sheets 102 may be referred to as laminates or laminations. The laminations may also be self-bonding such that the adhesive, glue, bonding material 104 may be activated for bonding such as by heat after stacking. The heat may be induced by baking in an oven or induction heating.

The adhesive, glue, or bonding material 104 may include a resin 106 and a filler 108. The resin 106 may adhere to steel and have favorable bonding strength. For example, the resin may be an epoxy resin or varnish.

The filler 108 may be a magnetic filler 108 having magnetic properties. Conventionally, the adhesive, glue, or bonding material 104 does not include a magnetic filler 108. Accordingly, adhesives, glues, or bonding materials may adversely prevent magnetic flux from passing perpendicularly or in the normal direction through the sheet 102 surfaces and may reduce the core stack saturation flux density. For example, non-ferromagnetic adhesives, glues, or bonding materials may have a relative magnetic permeability (μᵣ) in the normal direction (y) of approximately 1.0. Bonding material between iron-containing sheets (e.g., steel sheets) may act similar to air gaps. Bonding material and air gaps act to reduce the permeability along the normal direction (y) such that the core 100 has very low permeability and low saturation flux density. These effects may be further compounded by the addition of more layers consequentially including thicker adhesive, glue, or bonding material 104. For example, as the stacking factor moves away from 1.00 (i.e., decreases) the relative permeability (μᵣ) significantly decreases, as shown in FIG. 2. For instance, at a stacking factor of 1.0 the conventional lamination core may have a relative permeability (μᵣ) of at least 10,000 but at a stacking factor of 0.99 may have a stack normal direction relative permeability (μᵣ) of less than 100 or approximately 1.0. Accordingly, conventional laminated magnetic cores may only pass magnetic flux in the tangential direction (x) along the surface plane and have low magnetic flux and permeability (e.g., less than 250) in the normal direction (y) despite electrical steel laminations having a permeability (μᵣ) of approximately 10,000 or more.

However, magnetic core 100 having the adhesive, glue, or bonding material 104 with the magnetic filler 108 may have significantly relative permeability (μᵣ) in the normal direction (y) and a greater magnetic flux. For example, the relative permeability (μᵣ) at a stacking factor of 1.0 may be at least 8,000, or more preferably at least 9,000 or even more preferably at least 10,000 and at a stacking factor of 0.99 the relative permeability (μᵣ) may be at least 1,000 or more preferably at least 2,000, or even more preferably at least 3,000. The relative permeability (μᵣ) at a stacking factor of 0.99 may be 500 to 8,000, or more preferably 1,000 to 6,000, or even more preferably 2,000 to 4,000. At a stacking factor of 0.95, the relative permeability (μᵣ) may be at least 100, or more preferably at least 250, or even more preferably at least 500.

The magnetic filler 108 may be any particle or powder having magnetic properties. The magnetic filler 108 may be of different magnetic orders such as ferromagnetic or ferrimagnetic. For example, the magnetic filler 108 may be particles or powders of iron (Fe), cobalt (Co), nickel (Ni), alloys thereof, iron-silicon (FeSi), manganese-zinc (MnZn) ferrites, nickel-zinc (NiZn) ferrites, magnesium-manganese-zinc (MgMnZn) ferrites, cobalt-nickel-zinc (CoNiZn) ferrites, nickel (Ni) ferrites, cobalt (Co) ferrites, yttrium-iron garnet (e.g., Yt₃Fe₅O₁₂), or a combination thereof

The magnetic filler 108 may have conductive properties (i.e., be a conductor) or insulating properties (i.e., an insulator). Conductive magnetic filler 108 may be iron (Fe), cobalt (Co), nickel (Ni), alloys thereof, iron-silicon (FeSi) or combinations thereof. An insulating magnetic filler 108 may be manganese-zinc (MnZn) ferrites, nickel-zinc (NiZn) ferrites, magnesium-manganese-zinc (MgMnZn) ferrites, cobalt-nickel-zinc (CoNiZn) ferrites, nickel (Ni) ferrites, cobalt (Co) ferrites, yttrium-iron garnet (e.g., Yt₃Fe₅O₁₂), or a combination thereof.

The magnetic filler 108 may be particles or a powder having an average particle size or diameter of no more than 25 μm, or more preferably no more than 10 μm, or even more preferably no more than 5 μm. For example, the average particle size or diameter may be 1 nm to 25 μm, or more preferably 10 nm to 10 μm, or even more preferably 100 nm to 5 μm. The particles may be round, spherical, flakes or any other suitable shape.

The degree of magnetic properties may be altered by changing the loading or concentration of magnetic filler 108 in the bonding material 104. The magnetic filler 108 may be present in an amount such that the adhesive, glue, or bonding layer has a relative permeability (μᵣ) of at least 5, or more preferably at least 10, or even more preferably at least 25. For example, the adhesive, glue, or bonding material 104 may be loaded to a level such that the relative permeability (μᵣ) is from 1 to 100, or 5 to 60, or 20 to 45 (e.g., 30). The magnetic filler 108 may be greater than 10%, or more preferably greater than 50%, or even more preferably greater than 80% by weight of the adhesive, glue, or bonding material 104. For example, the magnetic filler 108 may be present at an amount of 10 to 99%, or even more preferably 50 to 97%, or even more preferably 80 to 95% by weight of the adhesive, glue, or bonding material 104. The adhesive, glue, or bonding layers may be no more than 5 mm, or more preferably no more than 2 mm, or even more preferably no more than 1 mm.

For example, Table 1 demonstrates the relative permeability (μᵣ) with respect to the stacking factor. The relative permeability (μᵣ) was calculated for both a conventional laminated core having a bonding material without any magnetic filler and a magnetic core as described herein with a magnetic filler (e.g., a bonding material with 90% FeSi powder by weight).

TABLE 1

| Bonding | | | Including | |
|---|---|---|---|---|
| Material | Conventional | | magnetic filler | |
| Stacking | (μᵣ = 1) | | (μᵣ = 30) | |
| factor | μ_{stack, n} | μ_{stack, t} | μ_{stack, n} | μ_{stack, t} |
| 1.0 | 10000 | 10000 | 10000 | 10000 |
| 0.995 | 196 | 9950 | 3757 | 9950 |
| 0.99 | 99 | 9900 | 2313 | 9900 |
| 0.97 | 33 | 9700 | 912 | 9700 |
| 0.95 | 20 | 9500 | 568 | 9502 |

The bonding material of the conventional laminated core has a relative permeability (μᵣ) in the normalized direction that is approximately 1.0 and the bonding material of the magnetic core disclosed herein and having a magnetic filler is approximately 30. The relative permeability (μᵣ) of the stacks in the normalized (μ_{stack,n}) and tangential (μ_{stack,t}) directions are shown. For example, at a stacking factor of 0.995 the conventional core has a relative permeability (μr) of 196 along the normalized direction and the magnetic core disclosed herein has a relative permeability (μᵣ) of 3757 which is significantly greater than the conventional core. Similarly, at a stacking factor of 0.95 the conventional laminated core has a permeability (μᵣ) of 20 and the magnetic core as disclosed herein has a permeability of 568—more than 25 times greater. As shown, the permeability (μᵣ) of the magnetic core disclosed herein is greater than 500 at a stacking factor of 0.95 or more.

Table 2 illustrates the magnetic properties of various conventional magnetic cores and the magnetic core disclosed herein and having magnetic filler in the bonding material or coating.

TABLE 2

| | | Electrical | Electrical steel |
|---|---|---|---|
| | | steel with | with adhesive |
| | | conventional | bonding + |
| | | adhesive | magnetic filler |
| Properties | SMC | bonding coating | coating |
| Magnetic | low, | high, highly | high, weakly |
| permeability (μ) | isotropic | anisotropic | anisotropic |
| Saturation flux | low | intermediate | high |
| density (Jₛ) | | | |
| 3D flux path | yes, | no | yes, weakly anisotropic |
| | isotropic | | |

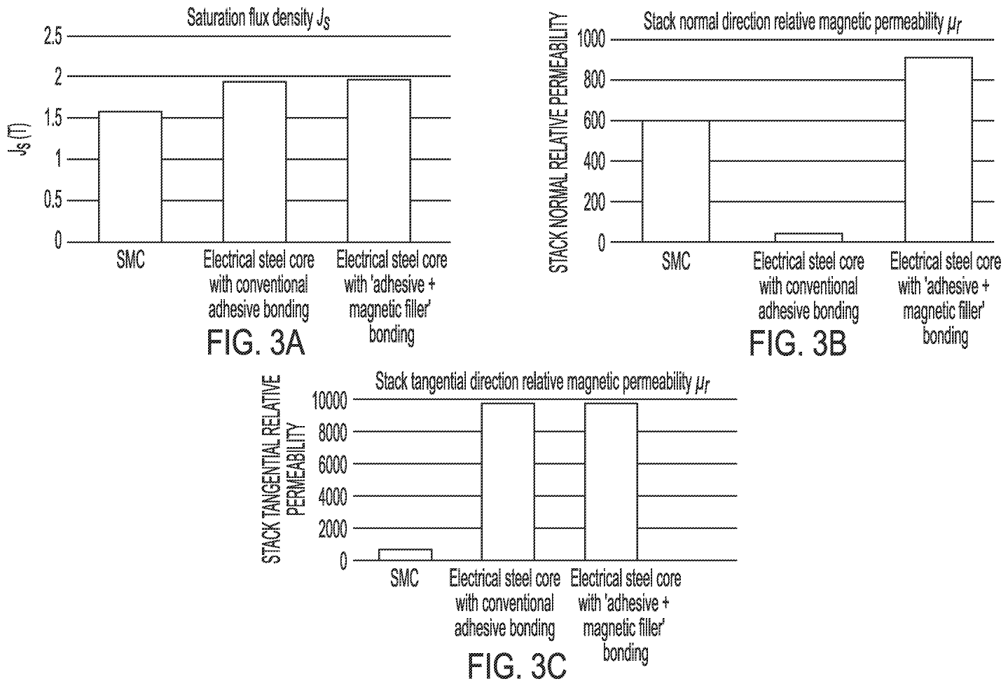

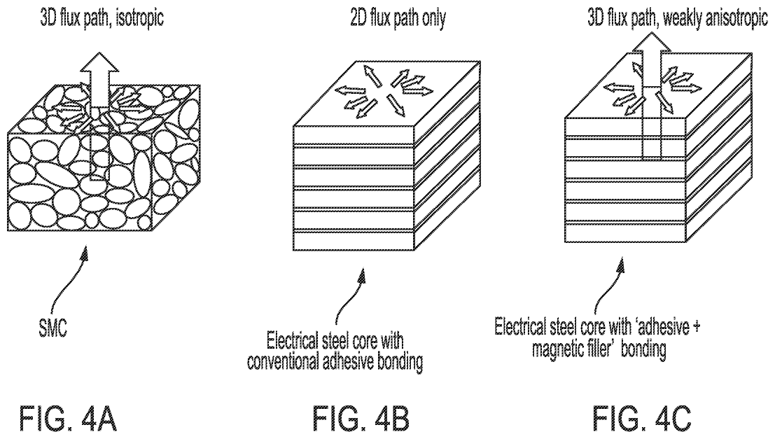

Table 2 is a summary of the results demonstrated in FIGS. 3A-C. The properties of a soft magnetic composite (SMC) core, a conventional laminate (i.e., without magnetic filler), and a core as disclosed herein (i.e., with magnetic filler). As can be seen in Table 2 and FIGS. 3A-C, the core as disclosed herein and having magnetic filler has beneficial properties similar to both the SMC cores and the conventional lamination cores. For example, FIGS. 4A-C demonstrate the magnetic flux paths of each, i.e., a SMC core (FIG. 4A), a conventional core (FIG. 4B), and the core as described herein (FIG. 4C).

Incorporating magnetic filler 108 into the bonding material allows for the formation of new magnetic circuit designs. For example, an electric machine or engine may incorporate many devices including magnetic cores. One or more of the magnetic cores may include magnetic filler 108 but not all the magnetic cores may include a magnetic filler 108. Accordingly, a magnetic machine may be designed to have components with different magnetic flux paths. For example, an electric machine may include a first component such as a rotor and a second component such as a stator each having a magnetic core. The first component (e.g., rotor core) may include a conventional magnetic core having steel laminations with a bonding material without magnetic filler such that it has a 2-D flux path. However, the second component (e.g., stator core) may include the magnetic core 100 as described herein (e.g., having steel laminations 102 with a bonding material 104 including magnetic filler 108) such that it has a 3-D flux path or vice versa.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A lamination core comprising:
a stack of iron-containing sheets; and
an adhesive between the iron-containing sheets, the adhesive including a resin and a magnetic filler.

2. The lamination core of claim 1, wherein the iron-containing sheets are steel sheets.

3. The lamination core of claim 2, wherein the resin is an epoxy resin.

4. The lamination core of claim 3, wherein the magnetic filler is electrically conductive.

5. The lamination core of claim 4, wherein the magnetic filler includes Fe, Co, Ni, alloys thereof, FeSi or a combination thereof.

6. The lamination core of claim 3, wherein the magnetic filler is an insulator.

7. The lamination core of claim 6, wherein the magnetic filler includes MnZn ferrites, NiZn ferrites, MgMnZn ferrites, CoNiZn ferrites, Ni ferrites, Co ferrites, yttrium-iron garnet, or a combination thereof.

8. The lamination core of claim 3, wherein the adhesive has a relative magnetic permeability (μᵣ) of at least 10.

9. An electric machine comprising:
steel laminations; and
a bonding material between the laminations, the bonding material including an epoxy resin and a magnetic filler dispersed therein.

10. The electric machine of claim 9, wherein the magnetic filler includes Fe, Co, Ni, alloys thereof, FeSi, MnZn ferrites, NiZn ferrites, MgMnZn ferrites, CoNiZn ferrites, Ni ferrites, Co ferrites, yttrium-iron garnet, or a combination thereof.

11. The electric machine of claim 10, wherein the magnetic filler has an average particle diameter of no more than 25 μm.

12. The electric machine of claim 11, wherein the magnetic filler has an average particle diameter of no more than 10 μm.

13. The electric machine of claim 10, wherein the magnetic filler is 10 to 99% by weight of the bonding material.

14. The electric machine of claim 13, wherein the magnetic filler is 50 to 97% by weight of the bonding material.

15. The electric machine of claim 13, wherein the magnetic filler is 80 to 95% by weight of the bonding material.

16. An electric machine comprising:
a first component having a first magnetic core including first laminations and a first adhesive therebetween, the first adhesive including a first resin such that the first magnetic core has a 2-D magnetic flux path; and
a second component having a second magnetic core including second laminations and a second adhesive therebetween, the second adhesive including a second resin and magnetic filler such that the second magnetic core has a 3-D magnetic flux path.

17. The electric machine of claim 16, wherein the magnetic filler includes Fe, Co, Ni, alloys thereof, FeSi, MnZn ferrites, NiZn ferrites, MgMnZn ferrites, CoNiZn ferrites, Ni ferrites, Co ferrites, yttrium-iron garnet, or a combination thereof.

18. The electric machine of claim 17, wherein the magnetic filler includes FeSi.

19. The electric machine of claim 17, wherein the first component is a rotor, and the second component is a stator.

20. The electric machine of claim 17, wherein the first component is a stator, and the second component is a rotor.
